(19) United States
(12) Patent Application Publication
(10) Pub. No.: US 2026/0209949 A1
(43) Pub. Date: Jul. 23, 2026

(54) METHOD AND APPARATUS FOR PRODUCING A COLD-SPRAYED MATERIAL APPLICATION

(71) Applicants: IMPACT-Innovations-GmbH, Rattenkirchen (DE); Helmut-Schmidt-Universität Universität der Bundeswehr Hamburg, Hamburg (DE)

(72) Inventors: Reeti SINGH, Mühldorf am Inn (DE); Jan KONDAS, Ampfing (DE); Martin LOHMAIER, Ramsau (DE); Andreas GROPP, Kirchdorf (DE); Leonhard HOLZGASSNER, Reichertsheim (DE); Sören NIELSEN, Kiel (DE); Frank GÄRTNER, Hamburg (DE); Thomas KLASSEN, Wentorf (DE); Alexander LIST, Hamburg (DE)

(21) Appl. No.: 19/455,518

(22) Filed: Jan. 21, 2026

(30) Foreign Application Priority Data
Jan. 22, 2025 (EP) 25153406.1

(51) Int. Cl. C23C 24/04

(52) U.S. Cl. CPC C23C 24/04

(57) ABSTRACT

This technology relates to a method and an apparatus for producing a material application 10 on a substrate surface 20 by means of cold spraying. Feedstock particles 14 and peening particles 16 are introduced into a process gas flow 20 in order to accelerate them. The accelerated particles 14 and peening particles 16 are directed in the process gas flow 20 onto the substrate surface. The feedstock particles 14 have a velocity to adhere to the substrate surface 30, thus forming the material application 10, and the peening particles 16 have a velocity that is too low for the peening particles 16 to adhere to the substrate surface 30. The feedstock particles 14 and the peening particles 16 comprise the same material or the same group of materials.

### CROSS-REFERENCE TO RELATED APPLICATIONS

This application claims priority to EP Patent Application No. 25153406.1 filed January 22, 2025, the entire contents of which are hereby incorporated by reference.

### FIELD

The technology relates to a method, in particular a cold-gas spraying method, for bonding and producing a material application on a substrate surface as well as an apparatus for producing a cold-sprayed material application on a substrate surface.

### BACKGROUND

Cold spraying (also termed “gas dynamic cold spray”) is a material application method that is characterised substantially by the use of kinetic energy. In the case of cold spraying, the feedstock material is neither fused nor melted.

In cold spraying, powder particles, i.e. the feedstock material, are accelerated through a process gas flow and directed at high velocity at a substrate surface to be coated. The powder particles adhere to this substrate surface. This material application can be carried out in different thicknesses.

To generate the process gas flow, a heated and pressurised process gas is accelerated through expansion in a convergent-divergent nozzle at high velocities (e.g. supersonic) and is cooled simultaneously. After the expansion, the temperature of the process gas flow can be in range of 100°C or even below. Possible process gases are nitrogen, carbon dioxide, helium, compressed air, water vapour, argon and suchlike. Similarly, mixtures of the aforementioned gases may be used as the process gas.

The powder particles are injected into the convergent region of the nozzle so that these are accelerated by the process gas. The powder particles can reach up to, for example, velocities of up to 1500 m/s in conventional cold spraying.

The powder particles impact on the substrate surface in a focused spray jet, deform simultaneously themselves and the substrate, at least on the surface, and form a firmly-adhering, dense, low-porosity material application with minimal oxidation. The thickness of the material application is variable and can amount to a few hundredths of a millimetre to several millimetres, or even to several centimetres.

In contrast to thermal spraying, such as flame spraying, the powder particles are neither fused nor melted in cold spraying. As the expanded process gas flow also has a temperature that is significantly below the melting point of the powder particles and a substrate material, the heat input in the substrate is low.

The method is particularly suitable for material applications, in particular coatings, repairs and corrosion protection as the thermal load due to the coating application is low and the material properties are largely retained. In addition, the method may be used for additive manufacturing of components.

To attain a particularly dense and low-porosity material application, helium can be used as the process gas in classic cold spraying. This enables, in comparison to nitrogen, for example, considerably higher velocities at the same temperature and thus increased kinetic energy of the powder particles. The increased kinetic energy results in low porosity and better cohesion of the applied material. However, the process costs from using helium are very high.

Furthermore, it is known to combine cold spraying with shot peening. For this combined method, the peening particles are added to the feedstock material. The peening particles are harder than the actual feedstock material and made of another material, e.g. made of premium steel or martensitic steel. The feedstock material comprises, for example, aluminium particles. The peening particles are also accelerated through the process gas flow and cause an additional deformation of the particles of the feedstock material upon impact on the substrate surface. Shot peening also results in low porosity and a high density of the applied material without necessarily needing to use expensive helium. However, it has been shown that the peening particles, or at least remnants thereof, are added into the applied material. This is undesirable as it causes foreign-material defects in the material application that can weaken the material application and, among other things, increase the risk of cracking and/or lead to corrosion.

### BRIEF DESCRIPTION

The object of example embodiments is to provide a method and an apparatus for producing a cold-sprayed material application on a substrate surface that overcomes the aforementioned disadvantages at least in part. In particular, material is to be applied to a substrate with the method and the apparatus, wherein the material application is characterised by good mechanical properties (such as minimal porosity, high adhesive tensile strength, high tensile strength and/or high elongation at break) and by good corrosion resistance.

The object is solved by means of a method, in particular a cold-spraying method, which is used to produce a material application and to apply a material on a substrate surface. The material application is formed by feedstock particles of a feedstock material.

The method comprises directing a process gas flow through a convergent-divergent nozzle arrangement. The nozzle arrangement comprises a convergent section and a divergent section which is downstream of the convergent section in the direction of flow. For example, the nozzle arrangement can comprise a Laval nozzle.

The process gas of the process gas flow can comprise, for example, nitrogen, carbon dioxide, helium, compressed air, water vapour, argon and suchlike. Similarly, gas mixtures, in particular mixtures of the aforementioned gases, such as nitrogen mixtures, may be used as the process gas.

Possible feedstock materials are aluminium, aluminium-based alloys (e.g. Al2024; Al6061, Al7050, Al7075, Al5083, Al6082), nickel, nickel-based alloys, magnesium, magnesium-based alloys, titanium, titanium-based alloys (e.g. Ti6Al4V, 3.7164), copper, copper-based alloys, zinc, zinc alloys, iron, iron-based alloys, cobalt, cobalt-based alloys, niobium, tantalum, and/or molybdenum. Further materials, such as steel, in particular high-alloy steels, are also possible.

The melting point of aluminium and aluminium-based alloys is approximately 600 °C. The melting point of nickel and nickel-based alloys is approximately 1400 °C. The melting point of magnesium and magnesium-based alloys is approximately 650 °C. The melting point of titanium and titanium-based alloys is approximately 1600 °C. The melting point of copper and copper-based alloys is approximately 1000 °C. The melting point of zinc and zinc alloys is approximately 420°C. The melting point of cobalt and cobalt-based alloys is approximately 1500°C and the melting point of iron, iron-based alloys and steels is approximately 1400°C to 1600°C.

Accordingly, the feedstock particles and the peening particles can comprise at least one of the following materials or consist of one of the following materials: aluminium, aluminium-based alloys, nickel, nickel-based alloys, magnesium, magnesium-based alloys, titanium, titanium-based alloys, copper, copper-based alloys, zinc, zinc alloys, iron, iron-based alloys, cobalt, cobalt-based alloys, niobium, tantalum, and/or molybdenum. Further materials, such as steel, in particular high-alloy steels, are also possible.

Feedstock particles and peening particles are also introduced into process gas flow. The introduced particles (feedstock particles - and peening particles) are then accelerated by means of the process gas flow directed through the nozzle arrangement.

The accelerated feedstock particles and peening particles in the process gas flow are directed onto the substrate surface. To this end, the process gas flow can be focussed by means of the nozzle arrangement. This enables the material to be applied locally and very precisely.

The feedstock particles have a velocity in order to adhere to the substrate surface, thus forming the material application. The peening particles have a velocity that is too low for adhesion to the substrate surface. It has been shown that the critical velocity at which the particles adhere to the substrate surface depends, among other things, on the particle temperature, particle size and the material of the particle. The critical velocity falls with increasing particle temperature. The particle velocity depends on the other hand, among other things, on the particle size.

The peening particles have a median particle size that is larger than the median particle size of the feedstock particles. Consequently, it is possible to only use the feedstock particles for the material application. The peening particles are not added to the material application, but rather are used to further deform the adhering feedstock particles upon impact. As a result, among other things, a particularly dense material application with low porosity can be attained. In addition, the material application exhibits good mechanical properties, such as high adhesive tensile strength, high tensile strength and/or high elongation at break.

Furthermore, the feedstock particles and the peening particles comprise the same material (for example Al6061), or the feedstock particles and the peening particles are made of the same group of materials (e.g. both are aluminium-based alloys).

The substrate can be made of the same material or the same group of materials as the feedstock material. It is however possible that the material application occurs on a substrate that is different from the feedstock material, thus comes from another group of materials. For example, it is possible that the method described here is used to apply a material application comprising aluminium and/or copper onto a steel substrate.

Here, group of materials is understood to mean alloys comprising the same base material (e.g. aluminium-based alloys, titanium-based alloys, nickel-based alloys, copper-based alloys and/or suchlike) but can be different in their further composition. For example, a combination of Al6061 as feedstock particle (melting point of 588°C) and aluminium or an aluminium-based alloy with a higher melting point as peening particle is possible.

By choosing the feedstock particle and peening particle from the same material or the same group of materials, it is possible to avoid the formation of foreign-material defects in the material application that can weaken the applied material and, among other things, increase the risk of cracking and/or lead to corrosion. Consequently, the material applications applied by means of the method described herein exhibit good mechanical strength, in particular high adhesive tensile strength, high tensile strength and/or high elongation at break, and/or good corrosion resistance.

Consequently, the method is particularly suited for repair applications. For example, defects in titanium or aluminium components, such as used in aviation, can be repaired quickly and economically using the method.

In one aspect, the feedstock particles comprise a first particle temperature and the peening particles a second particle temperature, wherein the first particle temperature is higher than the second particle temperature. As a result, a very pure material application can be made of feedstock particles can be produced.

In one aspect, the process gas flow in the divergent section of the nozzle arrangement can have a temperature that is below the melting point of the feedstock material. In particular, the temperature of the process gas flow is to be so low that the feedstock particles introduced into the process gas flow are not melted while being conveyed by the process gas flow and are also preferably not fused.

The introduction of the feedstock particles and/or the peening particles occurs preferably in the convergent section of the nozzle arrangement. Consequently, the particles can be directed and accelerated together with the process gas flow through the nozzle arrangement.

Similarly, it is also possible to introduce the feedstock particles and/or peening particles into the divergent section of the nozzle arrangement. Consequently, the particles are introduced into the already accelerated process gas flow and accelerated by this.

Furthermore, it possible to introduce a first portion of the particles (feedstock particles and/or peening particles) into the convergent section of the nozzle arrangement and a second portion of the particles (feedstock particles and/or peening particles) into the divergent section of the nozzle arrangement. For example, the feedstock particles can be introduced into the convergent section of the nozzle arrangement and the peening particles into the divergent section. The location of the introduction determines the length of time the particles spend in the process gas flow and consequently, among other things, the particle temperature and/or the particle velocity when impacting the substrate surface.

The introduction of the particles (feedstock particles and/or peening particles) occurs, for example, by means of a carrier gas. To this end, the carrier gas carries the particles (feedstock particles and/or peening particles) or a particle mixture (feedstock particles and/or peening particles) from a corresponding container and feeds the particles/the particle mixture to the corresponding section of the nozzle arrangement. The carrier gas can be the same gas as the process gas. Similarly, it is possible that the carrier gas and the process gas are different. Possible carrier gases are nitrogen, carbon dioxide, helium, compressed air, water vapour, argon and suchlike. Similarly, mixtures of the aforementioned gases may be used as the carrier gas.

In one aspect, the particles introduced into the process gas flow comprise 15 vol% to 40 vol% of feedstock particles and 60 vol% to 85 vol% of peening particles. Similarly, it is possible that the particles introduced into the process gas flow comprise 20 vol% to 35 vol% of feedstock particles and 55 vol% to 80 vol% of peening particles. It has been shown that this ratio of feedstock particles to peening particles results in a rapid material application and good mechanical properties.

Furthermore, the feedstock particles can have a median particle size in the range from 5 µm to 65 µm, or in the range from 15 µm to 50 µm or in the range from 20 µm to 45 µm, or in the range from 30 µm to 40 µm. The larger peening particles can have a median particle size in the range from 60 µm to 500 µm, or in the range from 90 µm to 350 µm or in the range from 150 to 320 µm, or in the range from 180 to 300 µm. The median particle size is typically indicated by the D50 value.

In one aspect, the feedstock particles and the peening particles are introduced into the process gas flow as a particle mixture. For example, a particle injection arrangement can be provided that ends in the convergent section of the nozzle arrangement and feeds both types of particles, i.e. the feedstock particles and the peening particles, into the process gas flow together. The ratio of feedstock particles and peening particles is predetermined, in this case, by the particle mixture provided to the particle injector. The particle mixture can be premixed and be provided from a container storing the particle mixture, or the particle mixture can be mixed by the particle injection arrangement. To this end, two separate containers are provided for the feedstock particles and the peening particles. The composition of the particle mixture in the method can be controlled by a corresponding valve.

Similarly, it is also possible to introduce the feedstock particles and the peening particles into the process gas flow separately. To this end, for example, two particle injection arrangements can be provided.

In one aspect, the feedstock particles are accelerated to a velocity ranging from 200 m/s to 2000 m/s or to a velocity ranging from 500 m/s to 1500 m/s, or to a velocity ranging from 800 m/s to 1000 m/s. Similarly, it is possible that the feedstock particles are accelerated to a velocity ranging from 200 m/s to 700 m/s or from 300 m/s to 500 m/s. This velocity is chosen so that the feedstock particles adhere to the substrate surface.

The peening particles, for example, can be accelerated to a velocity ranging from 100 m/s to 600 m/s or to a velocity ranging from 300 m/s to 550 m/s, or to a velocity ranging from 450 m/s to 500 m/s. Similarly, it is possible that the peening particles are accelerated to a velocity ranging from 100 m/s to 400 m/s or to a velocity ranging from 150 m/s to 300 m/s. The velocities are set, among other things, by the particle size of the particles. The size of the peening particles is set here so that the peening particles attain velocities which to do not result in the peening particles adhering to the substrate surface.

Furthermore, the feedstock particles upon impact on the substrate surface can have a temperature ranging from 20 °C to 800 °C, or a temperature ranging from 25 °C to 600 °C, or a temperature ranging from 100 °C to 500 °C, or a temperature ranging from 150 °C to 400 °C, or a temperature ranging from 200 °C to 300 °C. The peening particles upon impact on the substrate surface can have a temperature ranging from 25 °C to 300 °C, or a temperature ranging from 30 °C to 200 °C, or a temperature ranging from 50 °C to 120 °C, or a temperature ranging from 80 °C to 100 °C. The temperature upon impact is understood to mean the temperature of the particles that the particles have before being deformed by impacting the substrate surface.

The temperature of the particle upon impact on the substrate surface is influenced, among other things, by the temperature of the particles before and during introduction into the process gas flow. Further factors are the particle size and the length of time that the particles spend in the process gas flow. The length of time spent in the process gas flow can be influenced, among other things, by the injection position, injection direction and/or injection velocity of the particles.

In particular, the method can comprise controlling, in particular cooling, the temperature of the feedstock particles and/or peening particles before and/or during introduction into the process gas flow. The feedstock particles and peening particles may be temperature controlled together (for example, if these are introduced into the process gas flow as a particle mixture), or separately (for example, if these are introduced into the process gas flow separately).

In particular, the particles can be fed into the process gas flow at a temperature ranging from 0°C to 400 °C, or ranging from 10°C to 250°C, or ranging from 25° to 200°C. If the feedstock particles and the peening particles are temperature controlled separately, the peening particles can have a temperature that is below the temperature of the feedstock particles, for example, when being introduced into the process gas flow.

In one aspect, the process gas of the process gas flow is nitrogen or a nitrogen mixture. Nitrogen is (e.g. in comparison to helium) economical so that the process costs for producing a dense material application with low porosity can be reduced. Similarly, other gases such as carbon dioxide, helium, compressed air, water vapour, argon and/or gas mixtures can be used as the process gas.

In one further aspect, the process gas flow upstream of the convergent-divergent nozzle arrangement is heated to a temperature ranging from 200°C to 1400 °C, or ranging from 500°C to 1200°C. To this end, a heating arrangement can be provided. The velocity of the carrier gas flow (and thus the particle velocity) downstream of the nozzle arrangement can be influenced via the temperature upstream of the nozzle arrangement. Furthermore, the process gas flow upstream of the convergent-divergent nozzle can comprise a pressure ranging from 5 bar to 100 bar or ranging from 40 bar to 60 bar. The velocity of the process gas flow (and thus the particle velocity) downstream of the nozzle arrangement can also be influenced by the pressure.

Furthermore, the object is solved by means of an apparatus for producing a cold-sprayed material application on a substrate surface. The apparatus is configured to execute the method described above.

The apparatus comprises a heating arrangement for controlling the temperature of a process gas flow (for example, made of nitrogen or a nitrogen mixture). The heating arrangement is downstream of a convergent-divergent nozzle, wherein the nozzle arrangement comprises a divergent section and a convergent section. The divergent section is downstream of the convergent section in the direction of flow. Furthermore, the nozzle arrangement is configured to direct and accelerate the temperature-controlled process gas flow. The acceleration occurs by directing the temperature-controlled process gas flow through the convergent-divergent nozzle.

Furthermore, the apparatus comprises at least one particle injection arrangement. The particle injection arrangement is configured to introduce the feedstock particles and/or peening particles into the process gas flow.

In particular, the particle injection arrangement can be configured to introduce the feedstock particles and/or peening particles into the convergent section of the nozzle arrangement. Similarly, it is also possible that the particle injection arrangement is configured to introduce the feedstock particles and/or peening particles into the divergent section of the nozzle arrangement. Furthermore, it possible that the particle injection arrangement is configured to introduce a first portion of the particles (feedstock particles and/or peening particles) into the convergent section of the nozzle arrangement and a second portion of the particles (feedstock particles and/or peening particles) into the divergent section of the nozzle arrangement.

In addition, said at least one particle injection arrangement is configured to control, in particular to cool, the temperature of the feedstock particles and/or peening particles.

In one aspect, the particle injection arrangement comprises a temperature-controllable, in particular coolable, particle injector. For example, the particle injector can comprise a particle guide channel which is formed by a channel wall. The channel wall can comprise at least one cooling channel for channelling a cooling agent, in particular cooling water. The thermal performance and thus the particle temperature can be set by means of the temperature of the cooling agent and the flow rate.

Furthermore, the particle injection arrangement can be configured to introduce a particle mixture comprising feedstock particles and/or peening particles into the divergent section or the convergent section of the nozzle arrangement. To this end, a container can be provided with a premixed particle mixture, from which the particle mixture is extracted. Similarly, the particle mixture can be mixed first upstream of the particle injector. To this end, two separate containers are provided for the feedstock particles and for the peening particles. By means of corresponding metering devices (e.g. a volumetric feeder, comprising for example a conveyor disc, a conveyor screw, and/or suchlike), the composition of the particle mixture can be controlled.

It is also possible that the apparatus comprises at least two particle injection arrangements. In this case, a first particle injection arrangement can be configured to introduce feedstock particles into the divergent section or the convergent section of the nozzle arrangement. A second particle injection arrangement can be configured to introduce peening particles into the divergent section or the convergent section of the nozzle arrangement.

In addition, said at least one particle injection arrangement can be configured to introduce feedstock particles and/or peening particles into the process gas flow substantially in the direction of the process gas flow (particularly in the divergent section and/or the convergent section of the nozzle arrangement). In this case, the direction of the process gas flow and the injection direction of the particles form an angle α that amounts to 0°.

Said at least one particle injection arrangement can also be configured furthermore to introduce feedstock particles and/or peening particles into the process gas flow (particular into the divergent section and/or the convergent section of the nozzle arrangement) at an angle α≠0°, in particular substantially transverse (angle α is approximately 90°) to the direction of the process gas flow. The angle α can be in the range from 0° to 90°, or in the range from 30° to 60°, or at approximately 45°.

Furthermore, the apparatus can comprise in addition a process gas feeding device. The process gas feeding device can be configured to feed the process gas to the heating arrangement and/or said at least one particle injection arrangement.

### SHORT DESCRIPTION OF THE FIGURES

Example embodiments are explained exemplarily in more detail in the following by means of the enclosed figures. Here,

FIG. 1 shows a schematic flow diagram of a method for producing a cold-sprayed material application;

FIG. 2 shows a schematic illustration of the structure of the material application;

FIGS. 3A, 3B and 3C show schematic views of the apparatuses for producing a cold-sprayed material application;

FIG. 4 shows a further schematic view of the apparatuses for producing a cold-sprayed material application;

FIG. 5 shows a schematic detailed view of a particle injector; and

FIG. 6 shows a schematic velocity-temperature diagram.

### DETAILED DESCRIPTION OF EXAMPLE EMBODIMENTS

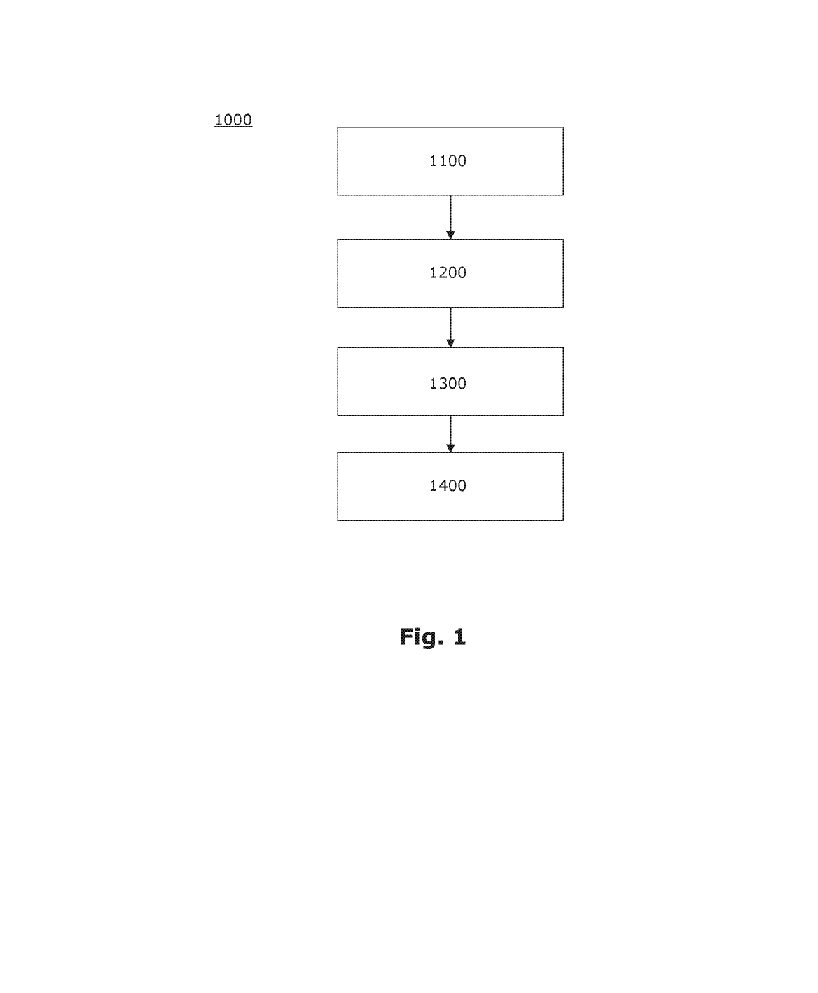

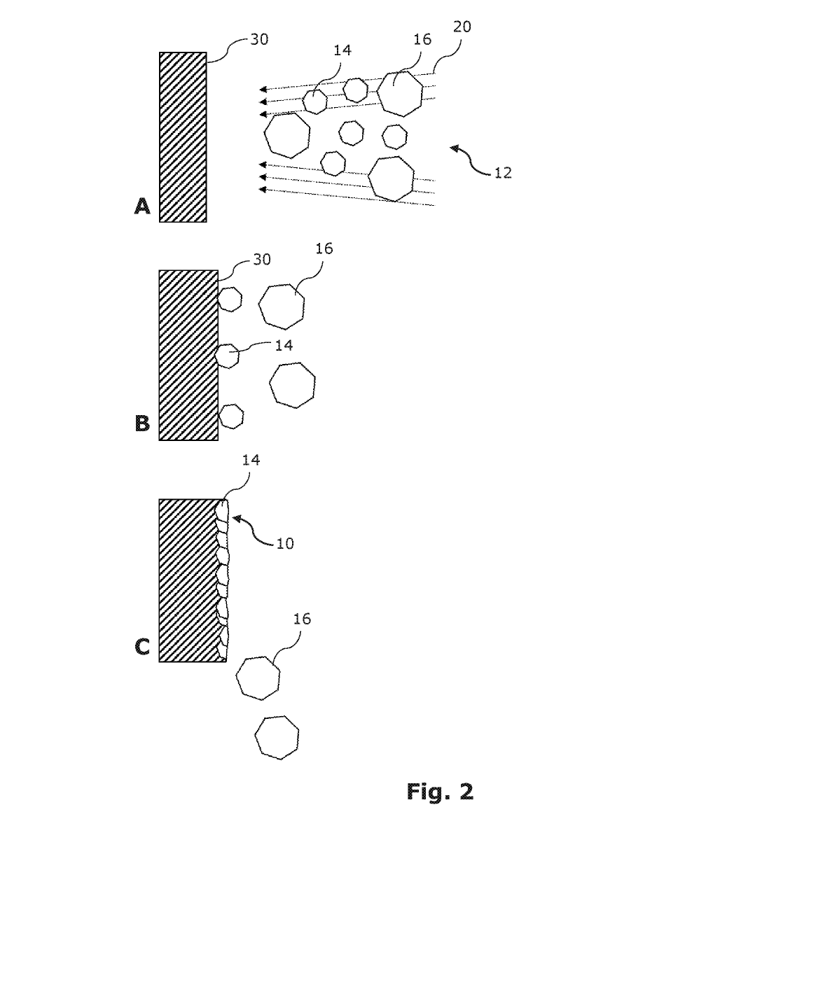

FIG. 1 shows a schematic flow diagram of a method 1000 for producing a cold-sprayed material application 10, as this is shown in FIG. 2. The method 1000 comprises the following steps:

Initially in step 1100, a process gas flow 20 (e.g. N₂ or a N₂ mixture) is directed through a convergent-divergent nozzle arrangement. The temperature of the process gas flow 20 is in a temperature range that prevents the melting of the feedstock particles introduced into the process gas flow.

In step 1200, feedstock particles 14 made of the feedstock material and peening particles 16 are introduced into the process gas flow 20. This introduction occurs, for example, in a convergent section of the nozzle arrangement. Similarly, it is also possible to introduce the particles (feedstock particles 14 and/or peening particles 16) into a divergent section of the nozzle arrangement.

Subsequently, the feedstock particles 14 and the peening particles 16 are accelerated (step 1300). The acceleration occurs by means of the process gas flow directed through the nozzle arrangement.

Thereafter, the accelerated feedstock particles 14 and peening particles 16 in the process gas flow 20 are directed onto the substrate surface (step 1400). To this end, the process gas flow 20 can be focussed. This step is shown again in more detail in FIG. 2.

The feedstock particles 14 have a velocity (e.g. 200 m/s to 2000 m/s) in order to adhere to the substrate surface 30, thus forming the material application 10 (see FIGS. 2B and 2C). The larger peening particles 16 have a velocity (e.g. 100 m/s to 600 m/s) that is too low for the peening particles 16 to adhere to the substrate surface 30 (see FIG. 2C). The peening particles 16 impact the substrate surface 30, densify there the material already applied (i.e. they deform the adhering feedstock particles further) and then fall off the substrate surface. The peening particles 16 can be captured, for example, and be reused or reprocessed.

The peening particles 16 have a median particle size that is larger than the median particle size of the feedstock particles 14. For example, the peening particles 16 can be three times, or at least four times, or at least five times, or at least eight times, or at least ten times, or at least 15 times larger than the feedstock particles (based on the particle diameter).

In addition, the feedstock particles 14 and the peening particles 16 are made of the same material or the same group of materials. Possible materials or groups of materials are aluminium, aluminium-based alloys, nickel, nickel-based alloys, magnesium, magnesium-based alloys, titanium, titanium-based alloys, copper, copper-based alloys, zinc, zinc alloys, iron, iron-based alloys, cobalt, cobalt-based alloys, niobium, tantalum, and/or molybdenum. Further materials, such as steel, in particular high-alloy steels, are also possible.

Moreover, the method can comprise controlling, in particular cooling, the temperature of the feedstock particles 14 and/or peening particles 16 before and/or during introduction (step 1200) into the process gas flow 20.

Similarly, the method can comprise controlling the temperature of the process gas upstream of the convergent-divergent nozzle, for example in a heating arrangement. In addition to the quantity of process gas (or its flow rate), the temperature of the process gas flow, among other things, also influences its pressure. The process gas flow 20 can be heated, for example, upstream of the convergent-divergent nozzle 100 to a temperature ranging from 200°C to 1400°C, and/or comprise a pressure ranging from 5 bar to 100 bar.

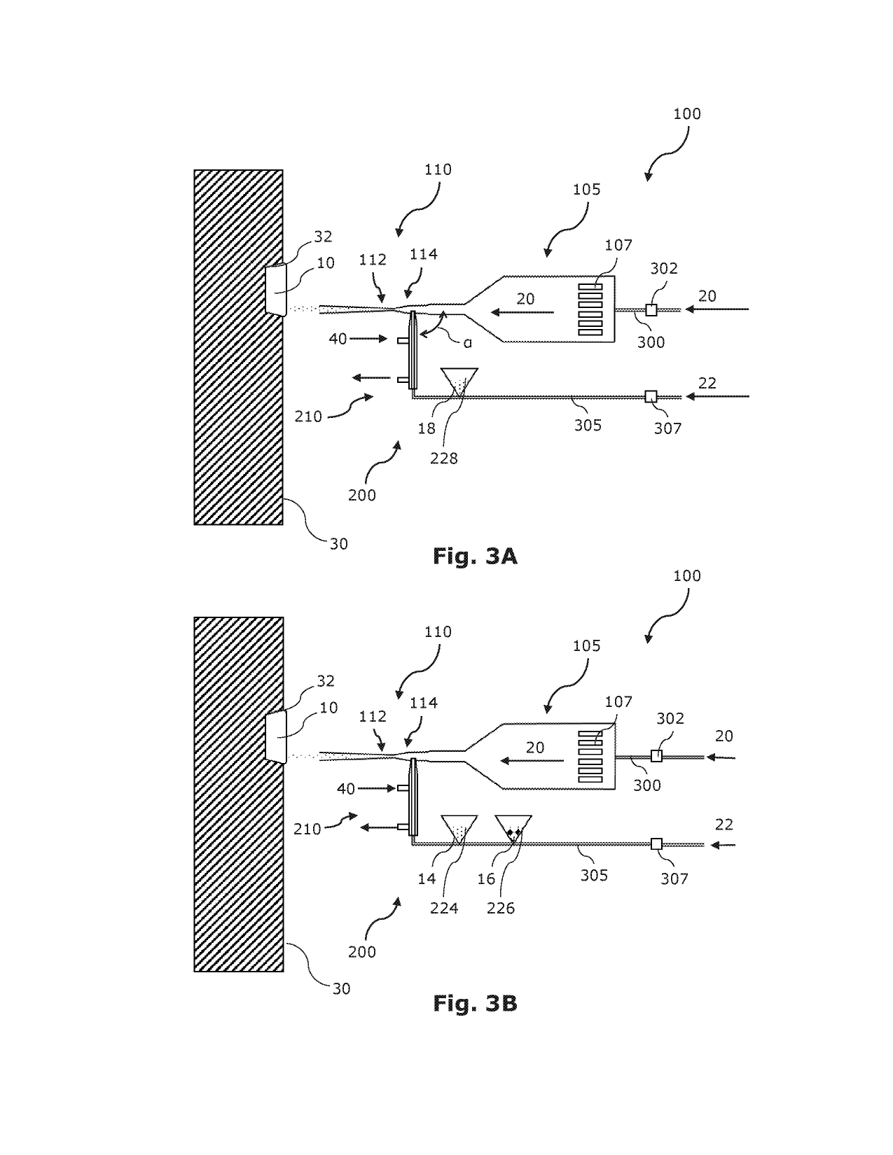

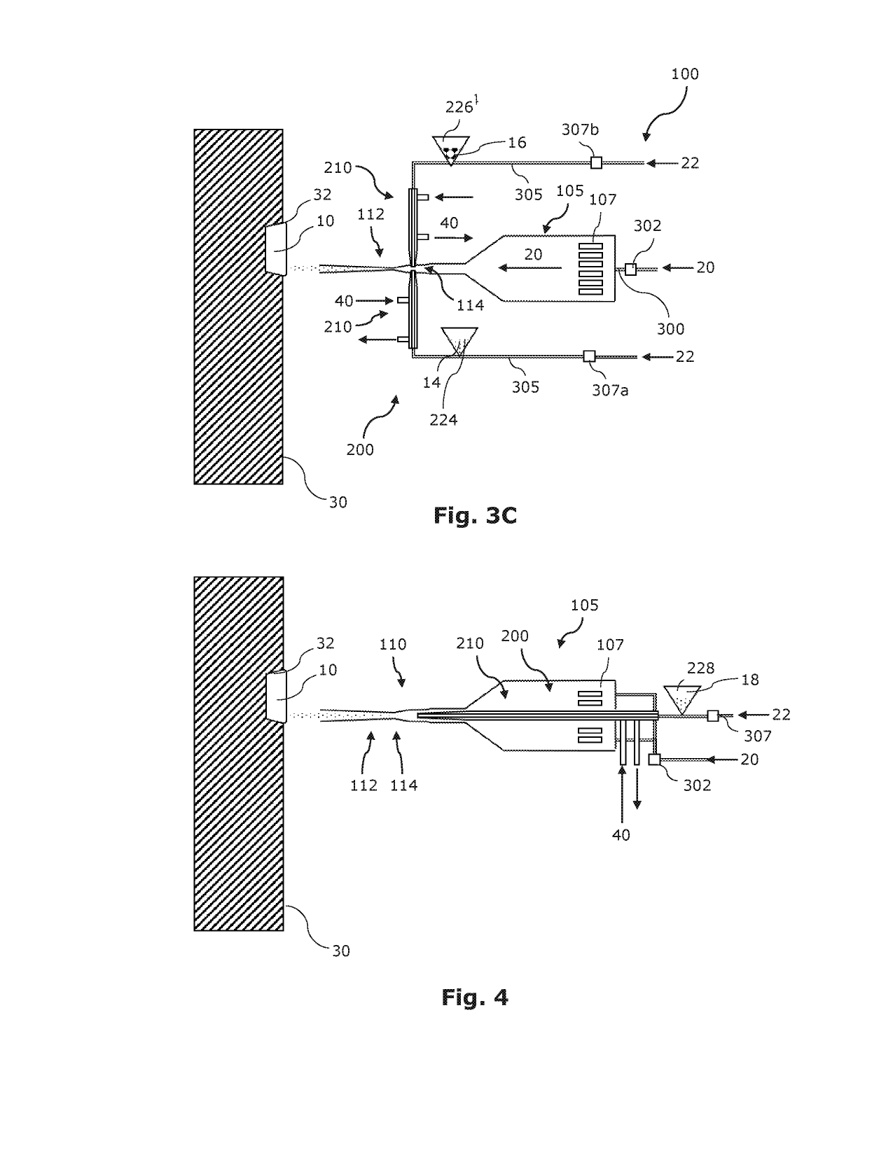

The FIGS. 3A, 3B and 3C show schematic views of apparatuses 100 for producing a cold-sprayed material application 10; In the apparatuses shown in FIGS. 3A, 3B and 3C, the particles (particle mixture 18, feedstock particles 14 and/or peening particles 16) are introduced into the convergent section 114 of the nozzle arrangement 110 substantially transverse (α ca. 90°) to the direction of flow of the process gas flow 20. In the apparatus shown in FIG. 4, the particles (particle mixture 18, feedstock particles 14 and/or peening particles 16) are introduced into the convergent section 114 of the nozzle arrangement 110 substantially in the direction of flow of the process gas flow 20 (α ca. 0°).

The FIGS. 3A, 3B, 3C and 4 also show that the particles are introduced into the convergent section 114 of the nozzle arrangement 110. It is however also possible that the particle injection arrangement 200 or the particle injector 210 are arranged in such a way that the particles (feedstock particles 14, peening particles 16 and/or a particle mixture 18) are introduced into the divergent section 112 of the nozzle arrangement. In addition, it is possible that a first portion of the particles (feedstock particles 14, peening particles 16 and/or a particle mixture 18) is introduced into the convergent section 114 of the nozzle arrangement 110, and a second portion of the particles (feedstock particles 14, peening particles 16 and/or a particle mixture 18) into the divergent section.

The apparatuses shown in FIGS. 3A, 3B, 3C and 4 are used to produce a cold-sprayed material application 10 on a substrate surface 30. The material application can be applied with a thickness in the sub-millimetre range to a thickness of several centimetres. For example, the substrate can comprise a defect 32, for example a scratch or a crack. By applying the material application 10, the defect can be closed and thus repaired.

The apparatuses 100 comprise a heating arrangement 105. Process gas can be directed into this heating arrangement via an optional process gas feeding device 300. The process gas feeding device 300 can control the process gas flow, in particular the flow rate. To this end, a corresponding controller, in particular a flow controller 302, can be provided.

The process gas is temperature controlled in the heating arrangement 105, which is upstream of the nozzle arrangement 110. To this end, for example, corresponding heating elements 107 are provided. In particular, a temperature can be controlled. The process gas 20 then passes the convergent-divergent nozzle 110 comprising a divergent section 112 and a convergent section 114. The process gas can be accelerated through the nozzle arrangement 110. The velocity of the process gas downstream of the nozzle arrangement can be controlled via the temperature and/or optionally the pressure of the process gas 20 upstream of the nozzle arrangement.

To introduce the feedstock particles 14 and the peening particles 16 into the process gas flow 20 (for example in the convergent section 114 of the nozzle arrangement 110), at least one particle injection arrangement 200 is provided. A carrier gas can be directed through the particle injection arrangement 200 via a carrier gas feeding device 305. The carrier gas is used to convey the particles 14, 16 into the process gas flow. The carrier gas feeding device 305 can control the carrier gas flow 22, in particular its flow rate. To this end, at least one corresponding controller, in particular a flow controller 307, 307a, 307b, can be provided. The quantity of particles (feedstock particles 14, peening particles 16 and/or a particle mixture 18) introduced into the process gas flow 20 via the carrier gas can be controlled via at least one metering device, such as a conveyor disc or a conveyor screw.

As shown in FIG. 3A exemplarily, the particle injection arrangement 200 can comprise a container 228, in which a particle mixture 18 comprising feedstock particles 14 and peening particles 16 is provided. Via a particle injector nozzle 210, the particle mixture 18 can be fed into the process gas flow 20, for example into the convergent section 114 of the nozzle arrangement 110, by means of the carrier gas 22. The introduced particles are captured and accelerated by the process gas flow 20. The particle-bearing process gas flow 20 can then be focussed and directed onto the substrate surface 30. The structure of the material application 10 is accomplished as has been explained in reference to FIG. 2.

As shown in FIG. 3B exemplarily, the particle injection arrangement 200 can comprise two separate containers 224, 226. Feedstock particles 14 are provided in a first container 224 and the peening particles 16 are provided in a second container 226. Both containers are connected to the particle injector 210, which feeds the particles provided by the respective containers 224, 226 into the process gas flow 20 (here in the convergent section 114 of the nozzle arrangement 110). This arrangement makes it possible to vary the ratio of peening particles 16 to feedstock particles 14. For example, the particles introduced into the process gas flow 20 can comprise 15 vol% to 40 vol% of feedstock particles 14 and 60 vol% to 85 vol% of peening particles 16.

The particles 14, 16 introduced into the nozzle arrangement 110 are captured and accelerated by the process gas flow 20. The particle-bearing process gas flow 20 can then be focussed and directed onto the substrate surface 30. The structure of the material application is accomplished as has been explained in reference to FIG. 2.

As shown further in FIG. 3C exemplarily, the particle injection arrangement 200 can comprise two separate containers 224, 226 each of which is allocated at least one particle injector 210.

feedstock particles 14 are loaded into a first container 224 and are provided to a first particle injector 210. This particle injector 210 feeds the feedstock particles 14 into the process gas flow 20. As shown here exemplarily, the feedstock particles 14 are conveyed by a carrier gas flow 22. This carrier gas flow 22 can be controlled by means of a controller 307a. For example, the quantity of the introduced feedstock particles 14 can be controlled via a metering device.

Peening particles 16 are loaded into a second container 226 and are provided to a second particle injector 210. This particle injector 210 feeds the peening particles 16 into the process gas flow 20. As shown here exemplarily, the peening particles 16 are conveyed by a carrier gas flow 22. This carrier gas flow 22 can be controlled by means of a controller 307b. For example, the quantity of the introduced peening particles 16 can be controlled via a metering device.

The position of introduction of the peening particles 16 and the feedstock particles 14 can be substantially identical (viewed in the direction of flow), or the peening particles 16 can be introduced into the process gas flow upstream or downstream of the feedstock particles 14. For example, the feedstock particles 14 and the peening particles 16 can be introduced into the convergent section 114 of the nozzle arrangement 110. Similarly, it is possible that the feedstock particles 14 are fed into the convergent section 114 of the nozzle arrangement 110 and the peening particles 16 into the divergent section 112. It is also possible that the feedstock particles 14 are introduced into the divergent section 112 of the nozzle arrangement and the peening particles 16 into the convergent section 114.

The apparatus shown in FIG. 3C makes it possible to introduce the feedstock particles 14 and the peening particles 16 separately and thus, among other things, to vary the ratio of peening and feedstock particles. The particles 14, 16 introduced into the process gas flow (particularly the nozzle arrangement 110) are captured and accelerated by the process gas flow 20. The particle-bearing process gas flow 20 can then be focussed and directed onto the substrate surface 30. The structure of the material application 10 is accomplished as has been explained in reference to FIG. 2.

In FIG. 4, a further apparatus is shown schematically. The structure substantially corresponds to the structure shown in FIG. 3A, i.e. a container 228 is provided with a premixed particle mixture 18 that is introduced into the process gas flow 200, here in the convergent section 114 of the nozzle arrangement. The apparatus 100 shown in FIG. 4 differs substantially in the injection direction of the particles 14, 16 or the particle mixture 18, which is orientated here in the direction of the process gas flow 20. It is understood that the apparatus shown in FIG. 4 can also be designed with separate containers 224, 226 and/or at least two separate particle injectors 210 (similar to FIG. 3C). Similarly, it is possible to provide at least one particle injector 210 orientated in the direction of the process gas flow 20 and at least one particle injector 210 orientated transverse to the direction of the process gas flow 20 in order to introduce the particles 14, 16 into the process gas flow 20.

In one aspect, the position of said at least one particle injector 210, in particular in the direction of the process gas flow 20, can be changeable in order to vary the injection position of the feedstock particles 14, the peening particles 16 and/or the particle mixture 18.

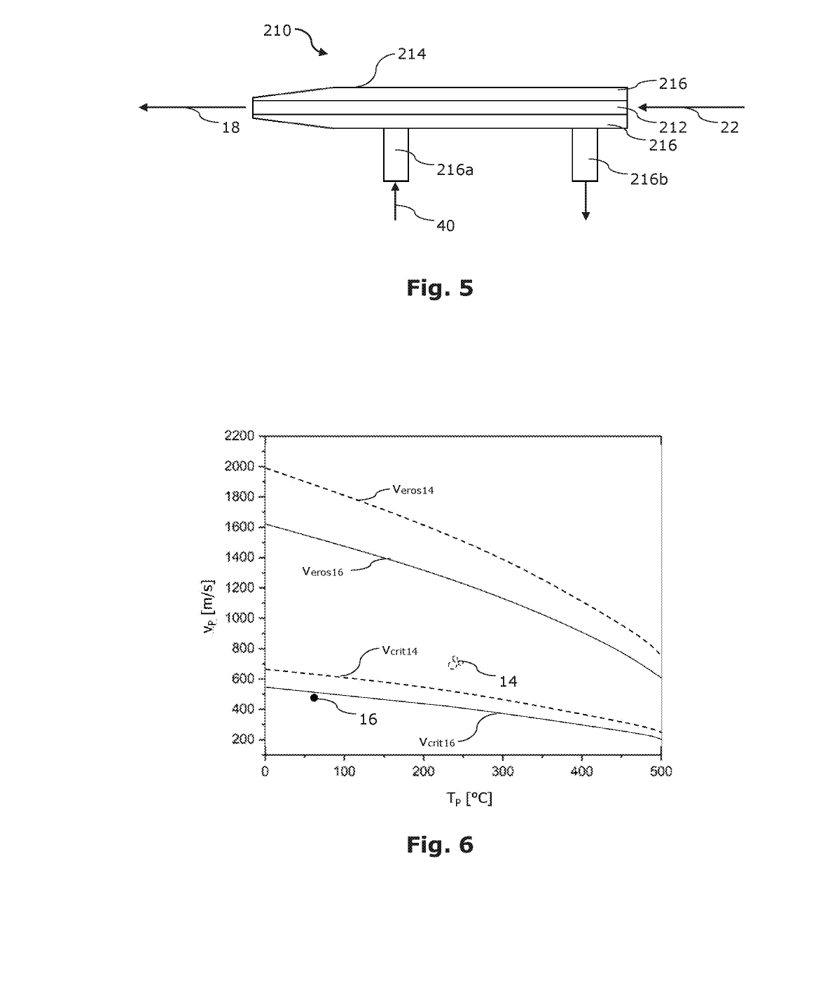

As shown in particular with reference to FIG. 5, the particle injection arrangement 200 is configured to control, in particular to cool, the temperature of the feedstock particles and/or peening particles. In particular, the particle injector 210 can be designed to be temperature-controllable or coolable. Thus, the temperature of feedstock particles 14, the peening particles 16 and/or the particle mixture 18 can be controlled, in particular cooled, before and during introduction into the process gas flow. If two separate particle injectors 210 are provided (e.g. see FIG. 3C), the feedstock particles 14 and the peening particles 16 can be temperature controlled individually.

As shown in FIG. 5, the particle injector 210 can comprise a particle guide channel 212. This can be located centrally. The particle guide channel 212 is formed by a channel wall 214. The channel wall 214 comprises at least one cooling channel 216 for channelling a cooling agent, in particular cooling water. For example, the channel wall 214 can be designed double walled so that a cooling channel is formed between the radially interior wall and radially exterior wall. Via a cooling agent inlet 226a, cooling agent can be fed to the particle injector 210, said cooling agent leaving the particle injector 210 via a cooling agent outlet 226b.

FIG. 6 shows a schematic velocity-temperature diagram which demonstrates the relationship between particle temperature and particle velocity for the adherence of the particles onto a substrate surface. The solid lines represent the critical velocity v_{crit16} of the peening particles 16 and the upper velocity vₑᵣₒₛ₁₆ of the peening particles 16. The dashed lines represent the critical velocity v_{crit14} of the feedstock particles 14 and the upper velocity vₑᵣₒₛ₁₄ of the feedstock particles 14. If the feedstock particles 14 and the peening particles 16 impact the substrate surface at a velocity and temperature that exceeds the upper velocity vₑᵣₒₛ₁₄ and vₑᵣₒₛ₁₆, then the material application does not occur. Instead, it results in erosion effects on the substrate surface.

Above the temperature-dependent critical velocity v_{crit14} or v_{crit16}, the particles 14, 16 adhere to the substrate surface. This results in the material application. Below the critical velocity v_{crit14} and v_{crit16}, there is no adhesion. As the exemplary points show, the feedstock particles 14 are directed at the substrate surface at a velocity and speed (here approximately, for example, 700m/s and 240°C) so that these adhere. In contrast, the peening particles 16 are directed at the substrate surface at a velocity and temperature (here approximately, for example, 500m/s and 70°C) so that these do not adhere but rather contribute to the consolidation of the material application. The shown velocity-temperature diagram is only exemplary. The critical velocity and the upper velocity are particularly dependent on the material of the used particles.

### LIST OF REFERENCE SIGNS

10 material application

12 feedstock material

14 feedstock particles

16 peening particles

18 particle mixture

20 process gas flow

22 carrier gas flow

30 substrate surface

32 defect in the substrate surface

40 cooling agent

100 apparatus

105 heating arrangement

107 heating element

110 nozzle arrangement

112 divergent section

114 convergent section

200 particle injection arrangement

210 particle injector

212 particle guide channel

214 channel wall

216 cooling channel

216a cooling agent inlet

216b cooling agent outlet

224 container

226 container

228 container

300 process gas feeding device

302 flow controller

305 carrier gas feeding device

307 flow controller

307a flow controller

307b flow controller

1100 directing the carrier gas flow

1200 introducing the particles

1300 accelerating the particles

1400 directing the particles

T_{P} particle temperature

v_{P} particle velocity

v_{crit14}critical velocity of feedstock particles

v_{crit16}critical velocity of peening particles

vₑᵣₒₛ₁₄upper velocity of feedstock particles

vₑᵣₒₛ₁₆upper velocity of peening particles

1. Method, in particular a cold-spraying method, for producing a material application on a substrate surface, wherein the material application is formed by feedstock particles of a feedstock material, and wherein the method comprises the following:
directing a process gas flow through a convergent-divergent nozzle;
introducing feedstock particles and peening particles into the process gas flow;
accelerating the feedstock particles and the peening particles by means of a process gas flow directed through the nozzle arrangement;
directing the accelerated feedstock particles and peening particles in the process gas flow onto a substrate surface, wherein the feedstock particles have a velocity to adhere to the substrate surface, thus forming the material application, and wherein the peening particles have a velocity that is too low for the peening particles to adhere to the substrate surface, wherein
the peening particles have a median particle size that is larger than the median particle size of the feedstock particles, and wherein
the feedstock particles and the peening particles comprise the same material or are made of the same group of materials.

2. Method according to claim 1, wherein
the introduction of the feedstock particles occurs in the convergent section of the nozzle arrangement and/or in the divergent section of the nozzle arrangement, and/or wherein
the introduction of the peening particles occurs in the convergent section of the nozzle arrangement and/or in the divergent section of the nozzle arrangement.

3. Method according to claim 1, wherein
the particles introduced into the process gas flow comprise 15 vol% to 40 vol% of feedstock particles and 60 vol% to 85 vol% of peening particles, or wherein
the particles introduced into the process gas flow comprise 20 vol% to 35 vol% of feedstock particles and 55 vol% to 80 vol% of peening particles, and/or wherein
the feedstock particles have a median particle size in the range from 5 µm to 65 µm, or in the range from 15 µm to 50 µm or in the range from 20 µm to 45 µm, or in the range from 30 µm to 40 µm, and/or wherein
the peening particles have a median particle size in the range from 60 µm to 500 µm, or in the range from 90 µm to 350 µm or in the range from 150 µm to 320 µm, or in the range from 180 µm to 300 µm.

4. Method according to claim 1, wherein the feedstock particles and the peening particles are introduced into the process gas flow as a particle mixture, or wherein the feedstock particles and the peening particles are introduced into the process gas flow separately.

5. Method according to claim 1, wherein
the feedstock particles are accelerated to a velocity ranging from 200 m/s to 2000 m/s or to a velocity ranging from 500 m/s to 1500 m/s, or to a velocity ranging from 800 m/s to 1000 m/s, or to a velocity ranging from 200 m/s to 700 m/s or to a velocity ranging from 300 m/s to 500 m/s, and/or wherein
the peening particles are accelerated to a velocity ranging from 100 m/s to 600 m/s or to a velocity ranging from 300 m/s to 550 m/s, or to a velocity ranging from 450 m/s to 500 m/s, or to a velocity ranging from 100 m/s to 400 m/s or to a velocity ranging from 150 m/s to 300 m/s.

6. Method according to claim 1, wherein
the feedstock particles upon impact on the substrate surface have a temperature ranging from 20 °C to 800 °C, or a temperature ranging from 25 °C to 600 °C, or a temperature ranging from 100 °C to 500 °C, or a temperature ranging from 150 °C to 400 °C, or a temperature ranging from 200 °C to 300 °C, and/or wherein
the peening particles upon impact on the substrate surface have a temperature ranging from 25 °C to 300 °C, or a temperature ranging from 30 °C to 200 °C, or a temperature ranging from 50 °C to 120 °C, or a temperature ranging from 80 °C to 100 °C.

7. Method according to claim 1, wherein the method furthermore
comprises controlling, in particular cooling, the temperature of the feedstock particles and/or peening particles before and/or during introduction into the process gas flow, wherein
the particles are introduced into the process gas flow, in particular, at a temperature ranging from 0°C to 400 °C, or ranging from 10°C to 250°C, or ranging from 25° to 200°C.

8. Method according to claim 1, wherein the feedstock particles and the peening particles comprise at least one of the following materials or consist of one of the following materials:
aluminium,
aluminium-based alloys,
magnesium,
magnesium-based alloys,
zinc,
zinc alloys,
nickel,
nickel-based alloys,
titanium,
titanium-based alloys,
copper,
copper-based alloys,
iron,
iron-based alloys,
cobalt,
cobalt-based alloys,
niobium,
tantalum, and/or
molybdenum.

9. Method according to claim 1, wherein the process gas of the process gas flow comprises at least one of the following gases:
nitrogen,
carbon dioxide,
helium,
compressed air,
water vapour, and/or
argon.

10. Method according to claim 1, wherein
the process gas flow upstream of the convergent-divergent nozzle arrangement is heated to a temperature ranging from 200°C to 1400 °C, or ranging from 500°C to 1200°C, and/or wherein
the process gas flow upstream of the convergent-divergent nozzle comprises a pressure ranging from 5 bar to 100 bar or ranging from 40 bar to 60 bar.

11. Apparatus for producing a cold-sprayed material application on a substrate surface, wherein the apparatus for implementing the method is configured according to claim 1, and wherein the apparatus comprises
a heating arrangement for controlling the temperature of the process gas flow, and
a convergent-divergent nozzle arrangement, said nozzle arrangement comprising a divergent section and a convergent section, wherein the nozzle arrangement is configured to direct and accelerate the temperature-controlled process gas flow, and wherein the apparatus furthermore
comprises at least one particle injection arrangement, wherein the particle injection arrangement is configured to introduce the feedstock particles and/or peening particles into the process gas flow, and wherein
said at least one particle injection arrangement is configured to control, in particular to cool, the temperature of the feedstock particles and/or the peening particles.

12. Apparatus according to claim 11, wherein said at least one particle injection arrangement comprises a temperature-controllable, in particular coolable, particle injector, and wherein
the particle injector optionally comprises a particle guide channel, which is formed by a channel wall, wherein the channel wall comprises at least one cooling channel for channelling a cooling agent, in particular cooling water.

13. Apparatus according to claim 11, wherein
the particle injection arrangement is configured to introduce a particle mixture comprising feedstock particles and peening particles into the divergent section or the convergent section of the nozzle arrangement, and/or wherein
the apparatus comprises at least two particle injection arrangements, wherein a first particle injection arrangement is configured to introduce the feedstock particles into the divergent section or the convergent section of the nozzle arrangement, and wherein a second particle injection arrangement is configured to introduce the peening particles into the divergent section or the convergent section of the nozzle arrangement.

14. Apparatus according to claim 11, wherein
said at least one particle injection arrangement is configured to introduce feedstock particles and/or peening particles substantially in the direction of the process gas flow into the divergent section and/or the convergent section of the nozzle arrangement, and/or wherein
said at least one particle injection arrangement is configured to introduce feedstock particles and/or peening particles into the divergent section and/or the convergent section of the nozzle arrangement at an angle α, in particular substantially transverse to the direction of the process gas flow.

15. Apparatus according to claim 11, wherein the apparatus comprises furthermore a process gas feeding device, and wherein the process gas feeding device is configured to feed the process gas to the heating arrangement and/or to said at least one particle injection arrangement.
